(19) United States
(12) Patent Application Publication
(10) Pub. No.: US 2024/0256888 A1
(43) Pub. Date: Aug. 1, 2024

(54) DYNAMIC REINFORCEMENT LEARNING

(71) Applicant: Telefonaktiebolaget LM Ericsson (publ), Stockholm (SE)

(72) Inventors: Jingya LI, GÖTEBORG (SE); Zhiqiang QI, BEIJING (CN); Xingqin LIN, SAN JOSÈ, CA (US); Anders ARONSSON, UDDEVALLA (SE); Hongyi ZHANG, GÖTEBORG (SE); Jan BOSCH, HOVÅS (SE); Helena HOLMSTRÖM OLSSON, Bunkeflostrand (SE)

(73) Assignee: Telefonaktiebolaget LM Ericsson (publ), Stockholm (SE)

(21) Appl. No.: 18/689,823

(22) PCT Filed: Dec. 21, 2021
(86) PCT No.: PCT/EP2021/086922

§ 371 Date: Mar. 6, 2024

(30) Foreign Application Priority Data
Sep. 7, 2021 (WO) PCT/CN2021/116892

(51) Int. Cl. G06N 3/092

(52) U.S. Cl. CPC G06N 3/092

(57) ABSTRACT

A method (400) for dynamic RL. The method includes using an RL algorithm to select a first action and triggering performance of the selected first action. The method also includes after the first action is performed, obtaining a first reward value (R1) associated with the first action. The method also includes using R1 and/or a performance indicator (P1) to determine whether an algorithm modification condition is satisfied. The method further includes, as a result of determining that the algorithm modification condition is satisfied, modifying the RL algorithm to produce a modified RL algorithm. In this way, the RL algorithm adapts to changes in the environment.

### TECHNICAL FIELD

This disclosure relates to reinforcement learning.

### BACKGROUND

Reinforcement Learning (RL) is a type of machine learning (ML) that enables an agent to learn by trial and error using feedback based on the actions that the agent triggers. RL has made remarkable progress in recent years and is now used in many applications, including real-time network management, simulations, games, etc. RL differs from the commonly used supervised and unsupervised ML approaches. Supervised ML requires a training data set with annotations provided by an external supervisor, and unsupervised ML is typically a process of determining an implicit structure in a data set without annotations.

The concept of RL is straightforward: an RL agent is reinforced to make better decisions based on the past learning experience. This method is similar to the different performance rewards that we encounter in everyday life. Typically, the RL agent implements an algorithm that obtains information about the current state of a system (a.k.a., “environment”), selects an action, triggers performance of the action, and then receives a “reward,” the value of which is dependent on the extent to which the action produced a desired outcome. This process repeats continually and eventually the RL agent learns, based on the reward feedbacks, the best action to select given the current state of the environment.

Although a designer sets the reward policy, that is, the rules of the game, the designer typically gives the RL agent no hints or suggestions as which actions are best for any given state of the environment. It's up to the RL agent to figure out which action is best to maximize the reward, starting from totally random trials and finishing with sophisticated tactics. By leveraging the power of search and many trials, RL is an effective way to accomplish a task. In contrast to human beings, an RL agent can gather experience from thousands of parallel gameplays if a reinforcement learning algorithm is run on a sufficiently powerful computer infrastructure.

### Q-Learning:

Q-learning is a reinforcement learning algorithm to learn the value of an action in a particular statue (see, e.g. reference [2]). Q-learning does not require a model of the environment, and theoretically, it can find an optimal policy that maximizes the expected value of the total reward for any given finite Markov decision process. The Q-algorithm is used to find the optimal action/selection policy: Q: S×A→ [symbol] (Eq. 1).

FIG. 1 illustrates the basic flow of Q-learning algorithm. Before learning begins, Q is initialized to a possibly arbitrary value. Then, at each time t the agent selects an action aₜ, observes a reward rₜ, enters a new state sₜ₊₁ (that may depend on both the previous state sₜ and the selected action), and Q is updated using the following equation:

$${Q}^{n e w} ( {s}_{t} , {a}_{t} ) ← Q ( {s}_{t} , {a}_{t} ) + α \cdot ( {r}_{t} + γ \cdot {max}_{a} Q ( {s}_{t + 1} , a ) - Q ( {s}_{t} , {a}_{t} ) ) \qquad ( Eq . 2 )$$

where α is the learning rate with 0<α≤1 and it determines to what extent newly acquired information overrides the old information, and γ is a discount factor with 0<γ≤1 and it determines the importance of future rewards.

### Deep Q-Learning:

A simple way of implementing Q-learning algorithm is to store the Q matrix in tables. However, this can be infeasible or not efficient when the number of states or actions becomes large. In this case, function approximation can be used to represent Q, which makes Q-learning applicable to large problems. One solution is to use deep learning for function approximation. Deep learning models consist of several layers of neural networks, which are in principle responsible for performing more sophisticated tasks like nonlinear function approximation of Q.

Deep Q-learning is a combination of convolutional neural networks with the Q-learning algorithms. It uses deep neural network with weights θ to achieve an approximated representation of Q. In addition, to improve the stability of the deep-Q learning algorithm, a method called experience replay was proposed to remove correlations between samples by using a random sample from prior actions instead of the most recent action to proceed (see, e.g., reference [3]). The deep Q-learning algorithm with experience replay proposed in reference [3] is shown in the table below. After performing experience replay, the agent selects and executes an action according to an ε-greedy policy. ε defines the exploration probability for the agent to perform a random action.

Algorithm 1 Deep Q-learning with Experience Replay

```
  Initialize replay memory [symbol]  to capacity N
  Initialize action-value function Q with random weights
  for episode = 1, M do
    Initialise sequence s₁ = {x₁} and preprocessed sequenced ϕ₁ = ϕ(s₁)
    for t = 1,T do
      With probability ϵ select a random action aₜ
      otherwise select aₜ = maxₐ Q*(ϕ(sₜ), a; θ)
      Execute action aₜ in emulator and observe reward rₜ and image xₜ₊₁
      Set sₜ₊₁ = sₜ, aₜ, xₜ₊₁ and preprocess (ϕₜ₊₁ = ϕ(sₜ₊₁)
      Store transition (ϕₜ, aₜ, rₜ, ϕₜ₊₁) in [symbol]
      Sample random minibatch of transitions (ϕⱼ, aⱼ, rⱼ, ϕⱼ₊₁) from [symbol]
      $Set {y}_{j} = \{ \begin{matrix}{r}_{j} & for terminal {ϕ}_{j + 1} \\ {r}_{j} + γ {max}_{{a}^{′}} Q ( {ϕ}_{j + 1} , {a}^{′} ; θ ) & for non - terminal {ϕ}_{j + 1}\end{matrix}$
      Perform a gradient descent step on (yⱼ − Q(ϕⱼ, aⱼ; θ))² according
      to equation 3
    end for
  end for
```

### SUMMARY

As noted above, reinforcement learning has been successfully used in in many use cases (e.g., cart-pole problem solving, robot locomotion, Atari games, Go Games, etc.) where the RL agent is dealing with a relatively static environment (the set of states don't change), and it is possible to obtain all possible environment states, which is known as “full observability.”

Theoretically, RL algorithms can also cope with the dynamic changing environment if sufficient data can be collected to abstract the changing environment and there is sufficient time for training and trials. These requirements, however, can be difficult to meet in practice because large data collection can be complex, costly, and time consuming, or even infeasible. In many cases, it is not possible to have the full observability of the dynamic environment, e.g., when quick decision needs to be taken, or when it is difficult/infeasible to collect data for some features. On example is a public safety scenario, where an unmanned aerial vehicle (UAV) (a.k.a., drone) carrying base station (“UAV-BS”) needs to be deployed quickly in a disaster area to provide wireless connectivity for mission critical users. It is important to adapt the UAV-BS' configuration and location to the real-time mission critical traffic situation. For instance, when the mission critical users move on the ground and/or when more first responders join the mission critical operation in the disaster area, the UAV-BS should quickly adapt its location and configuration to maintain the service continuity in this changing environment.

This disclosure aims at mitigating the above problem. Accordingly, in one aspect there is provided a method for dynamic RL. The method includes using an RL algorithm to select a first action and triggering performance of the selected first action. The method also includes after the first action is performed, obtaining a first reward value (R1) associated with the first action. The method also includes using R1 and/or a performance indicator (PI) to determine whether an algorithm modification condition is satisfied. The method further includes, as a result of determining that the algorithm modification condition is satisfied, modifying the RL algorithm to produce a modified RL algorithm. In this way, the RL algorithm adapts to changes in the environment.

In another aspect there is provided a computer program comprising instructions which when executed by processing circuitry of a RL agent causes the RL agent to perform any of the methods disclosed herein. In one embodiment, there is provided a carrier containing the computer program wherein the carrier is one of an electronic signal, an optical signal, a radio signal, and a computer readable storage medium.

In another aspect there is provided an RL agent node that is configured to use an RL algorithm to select a first action and trigger performance of the selected first action. The RL agent is also configured to, after the first action is performed, obtain a first reward value (R1) associated with the first action. The RL agent is also configured to use R1 and/or a performance indicator (PI) to determine whether an algorithm modification condition is satisfied. The RL agent is also configured to, as a result of determining that the algorithm modification condition is satisfied, modify the RL algorithm to produce a modified RL algorithm. In some embodiments, the RL agent comprises memory and processing circuitry coupled to the memory, wherein the memory contains instructions executable by the processing circuitry to configure the RL agent to perform the methods/processes disclosed herein.

An advantage of the embodiments disclosed herein is that they provide an adaptive RL agent that is able to operate well in a dynamic environment with limited observability of the environment and/or changing state sets over time. That is, embodiments can handle complex system optimization and decision-making problems in dynamic environment with limited environment observability and dynamic state space. Compared to a convention non-adaptive RL agent, the embodiments disclosed herein can respond to changes in the environment and update its RL algorithm to achieve an acceptable level of service quality. In addition, conventional RL agents need to have a retrained RL algorithm completely from scratch when entering a different environment, whereas the embodiment can reuse part of the past learned experience with adjusted algorithm parameters to provide proper and timely decisions in the subsequent changing environments.

### BRIEF DESCRIPTION OF THE DRAWINGS

The accompanying drawings, which are incorporated herein and form part of the specification, illustrate various embodiments.

FIG. 1 illustrates the basic flow of Q-learning algorithm.

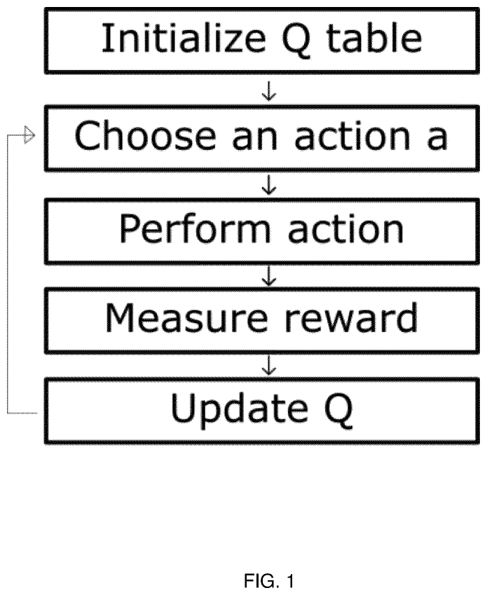

FIG. 2 illustrates an RL system according to some embodiments.

FIG. 3 illustrates a UAV-BS serving a mission-critical UE.

FIG. 4 is a flowchart illustrating a process according to some embodiments.

FIG. 5 is a block diagram of an RL agent according to some embodiments.

### DETAILED DESCRIPTION

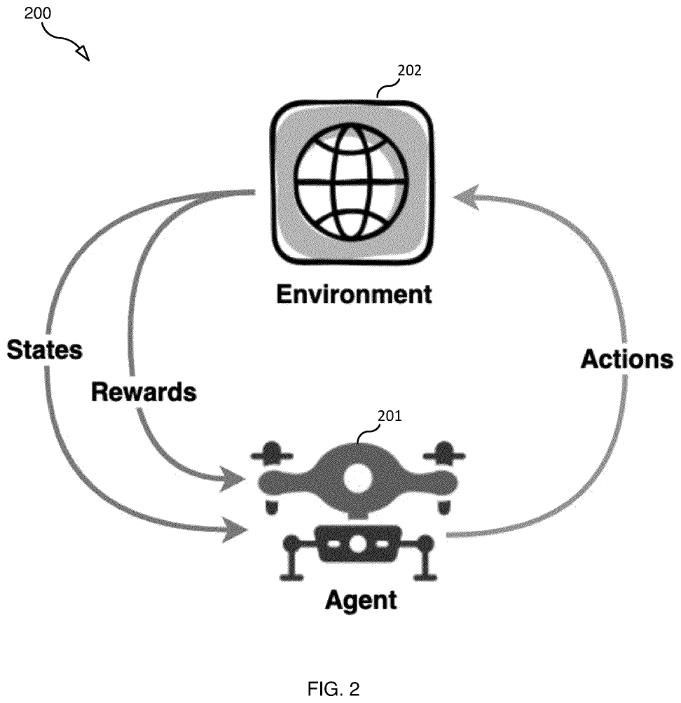

FIG. 2 illustrates an RL system 200 according to some embodiments. The RL system consists of an RL agent 201 (or “agent” for short), a set of environment states S, and a set of actions A per state. By performing an action in the environment 202, the environment 202 may transition from one state to another state and the agent 201 receives an immediate “reward” after taking this action. More formally, at a given time t, the agent 201 obtains the current state sₜ of the environment 202, and then selects an action at from the set of available actions associated with the current state, which action is subsequently performed. After the action is performed the environment 202 moves to a new state sₜ₊₁ and the agent receives a award rₜ associated with the transition (sₜ, aₜ, sₜ₊₁). The goal of the agent 201 is to learn a policy that maximizes the expected cumulative reward. The policy may be a map or a table that gives the probability of taking an action a when in a state s.

Agent 201 is configured to adapt the RL algorithm that is employs to select the actions. This enables, among other things, fast decision making in a dynamic environment with limited or/and changing state sets over time. The agent 201, in one embodiment, preforms the following steps: 1) the agent 201 monitors a first set of one or more parameters, 2) the agent 201, based on monitored parameter(s), adjusts the RL algorithm (e.g., adjusts a second set of one or more parameters) to adapt the RL algorithm to the new environment, and 3) selects action using the modified RL algorithm.

In one embodiment, the first set of parameters includes at least one or a combination of the following: 1) The received immediate reward rₜ at a given time t, 2) an accumulated reward Σₜ₌ᵢ^{j}rₜ during a time window, i.e., from time i to time j; and 3) a performance indicator (e.g., a key performance indicator (KPI)). For the UAV-BS in the public safety scenario described above, examples of KPIs include: the drop rate of mission critical users; the worst mission critical user throughput; the wireless backhaul link quality; etc.

With respect to the accumulated reward, in some embodiments the time window is decided based on: i) the correlation time (changing-scale) the environment and/or ii) application requirements, e.g., the maximum allowed service interruption time. In other embodiments, the time window is the time duration from the beginning till now.

Dynamic changing of environment (e.g., user equipment (UE) movements, UAV movements, or/and backhaul connection links of the UAV-BS in the public safety scenario) can result in the change of value(s) of one or a combination of the first set of parameters. By detecting/observing such changes, the agent 201 can automatically adapt the RL algorithm to fit the new environment.

The triggering event for adjusting the second set of parameters at a given time t can be at least one or a combination of the following:
The immediate reward rₜ is less than a lower-bound threshold.
The immediate reward rₜ is greater than an upper-bound threshold.
The difference between the immediate reward at time t and the previous time instance t−1, i.e., rₜ₋₁−rₜ, is larger than a pre-defined threshold.
The accumulated reward Σₜ₌ᵢ^{j}rₜ is less than a lower-bound threshold.
The accumulated reward Σₜ₌₁^{j}rₜ is greater than an upper-bound threshold.
The difference between the accumulated reward in the current time window [i, j] and the one in the previous time window [i−k, j−k], i.e., Σₜ₌ᵢ₋ₖ^{j-k}rₜ−Σₜ₌ᵢ^{j}rₜ is larger than a defined threshold.
A key performance parameter is less than a lower-bound threshold.
A key performance parameter is greater than an upper-bound threshold.
In all above events, the thresholds can either be pre-defined or dynamically changed based on the changing service requirements or/and changing environment.

In one embodiment, the second set of parameters consists of algorithm related parameters. The Second set of parameters can include at least one or a combination of the following: i) the exploration probability ε; ii) the learning rate (α; iii) the discount factor γ; iv) and the replay memory capacity N.

In one example, the exploration probability E can be increased to a certain value when an event (e.g., immediate reward is dropped below a threshold) has triggered the update of the algorithm. In another example, the exploration probability E can be reduced to a certain value when another event (e.g., accumulated reward has reached an upper-bound threshold) has triggered the update of the algorithm.

In one example, the learning rate a can be increased to a certain value when an event (e.g., immediate reward is dropped below a threshold) has triggered the update of the algorithm. In another example, the learning rate a can be reduced to a certain value when another event (e.g., accumulated reward has reached an upper-bound threshold) has triggered the update of the algorithm.

In one example, the discount factor γ can be increased to a certain value when an event (e.g., immediate reward is dropped below a threshold) has triggered the update of the algorithm. In another example, the discount factor γ can be reduced to a certain value when another event (e.g., accumulated reward has reached an upper-bound threshold) has triggered the update of the algorithm.

In one example, the replay memory capacity N can be increased to a certain value when an event (e.g., immediate reward is dropped below a threshold) has triggered the update of the algorithm. In another example, the replay memory capacity N can be reduced to a certain value when another event (e.g., accumulated reward has reached an upper-bound threshold) has triggered the update of the algorithm.

The table below shows pseudo-code for a dynamic reinforcement learning process that is performed by agent 201 in one embodiment.

Algorithm 2: Dynamic Reinforcement Learning with reward value
monitor and adaptive exploration probability

```
  Initialize replay memory D to capacity N
  Initialize action-value function Q with two random sets of weights θ, θ′
  Initialize exploration probability ε to 1
  Initialize restarting exploration probability ε_{ReStart} to 0.1
  Initialize ending exploration probability ε_{End} to 0.001
  Initialize rₚᵣₑᵥᵢₒᵤₛ equal to 0
  for Iteration = 1, M do
    for t = 1, K do
      Select a random action aₜ with probability ε
      $Otherwise , select {a}_{t} = arg {max}_{a} Q ( {s}_{t} , a ; θ )$
      Execute action aₜ, collect reward rₜ
      Observe next state sₜ₊₁
      Store the transition (s_{t,} aₜ, rₜ, sₜ₊₁) in D
      Sample mini-batch of transitions (sⱼ, aⱼ, rⱼ, sⱼ₊₁) from D
      if sⱼ₊₁ is terminal then
        Set yⱼ = rⱼ
      else
        ${y}_{j} = {r}_{j} + γ {max}_{{a}^{′}} Q ( {s}_{j + 1} , {a}^{′} ; {θ}^{′} )$
      end if
      Perform a gradient descent step using targets yⱼ
      with respect to the online parameters θ
      Set θ′ ← θ
    end for
    if rₚᵣₑᵥᵢₒᵤₛ − r_{K} > Drop threshold then
      ε = ε_{ReStart}
    else if r_{K} > Upper reward threshold then
      ε = ε_{End}
    else
      ε = ε × 0.995
    end if
    rₚᵣₑᵥᵢₒᵤₛ = r_{K}
  end for
```

As seen from the above code, the exploration probability E is adjusted when there is a reward value drop greater than a threshold (a.k.a., the “Drop” threshold). Following the completion of each learning iteration, the last reward value r_{K} will be checked and compared to a pre-defined performance drop tolerant threshold and an upper reward threshold. The adjustment is made to exploration probability ε based on the reward value r_{K} and the two thresholds.

In this example, the first set of parameters includes the immediate reward r_{K}, and the second set of parameters consists of the exploration probability ε. There are two triggering events for updating this algorithm related parameter:
1) when the immediate reward r_{K} is greater than an upper-bound reward threshold, then the exploration probability ε is reduced to a certain value (e.g., ε=ε_{End});
2) when difference between the immediate reward r_{K} and a previous reward rₚᵣₑᵥᵢₒᵤₛ is larger than a pre-defined drop threshold, then the exploration probability E is increased from the ending probability ε=0.001 to ε=ε_{ReStart}.

### Use Case Example

Stable connectivity is crucial for improving the situational awareness and operational efficiency in various mission-critical situations. In a catastrophe or emergency scenario, the existing cellular network coverage and capacity in the emergency area may not be available or sufficient to support mission-critical communication needs. In these scenarios, deployable-network technologies like portable base stations (BSs) on UAVs or trucks can be used to quickly provide mission-critical users with dependable connectivity.

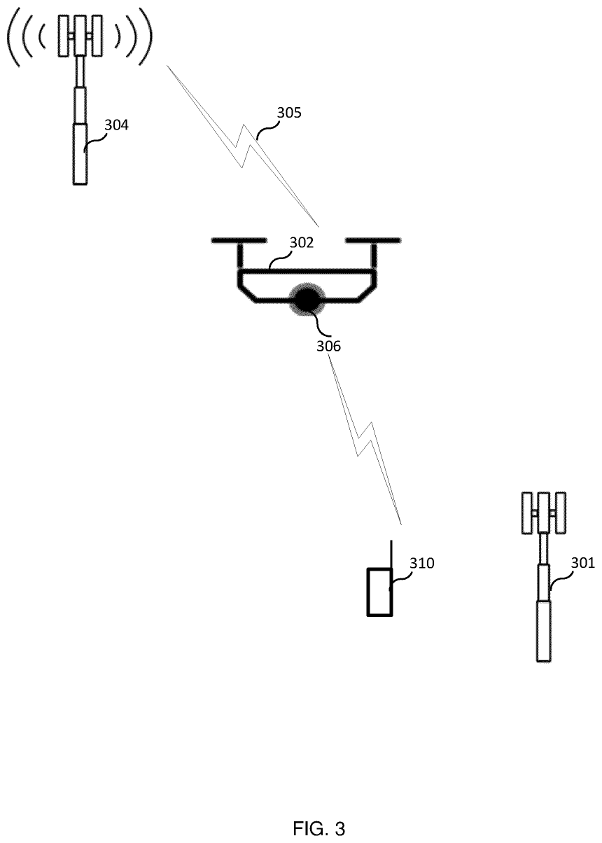

FIG. 3 illustrates a mission-critical scenario, where a macro BS 301 is damaged due to a natural disaster and a UAV-BS 302 is set up to provide temporary wireless access connection to mission-critical users (exemplified by UE 310) that are performing search and rescue missions in the disaster area. The UAV-BS 302 is integrated into the cellular network by logically connecting itself to an on-ground donor BS 304 (e.g., a macroBS) using a wireless backhaul link 305. The same UAV-BS antenna 306 may be used for both the access and the backhaul links.

In order to best serve the on-ground mission-critical users, and, at the same time, maintaining a good backhaul connection, agent 201 can be employed to autonomously configure the location of the UAV-BS and the electrical tilt for the access and backhaul antenna of the UAV-BS. By employing the RL algorithm adaptation processes disclosed herein, agent 201 is be able to adapt its RL algorithm to the real-time changing environment (e.g., when mission-critical traffic moves on the ground), where traditional reinforcement learning algorithms are not applicable and would result in inappropriate UAV-BS configuration decisions. That is, the agent 201 can be used to automatically control the location of the UAV-BS 302 and the antenna configuration of the UAV-BS in a dynamic changing environment, in order to best serve the on-ground mission critical users and at the same time, maintaining a good backhaul connection between the UAV-BS and an on-ground donor base station.

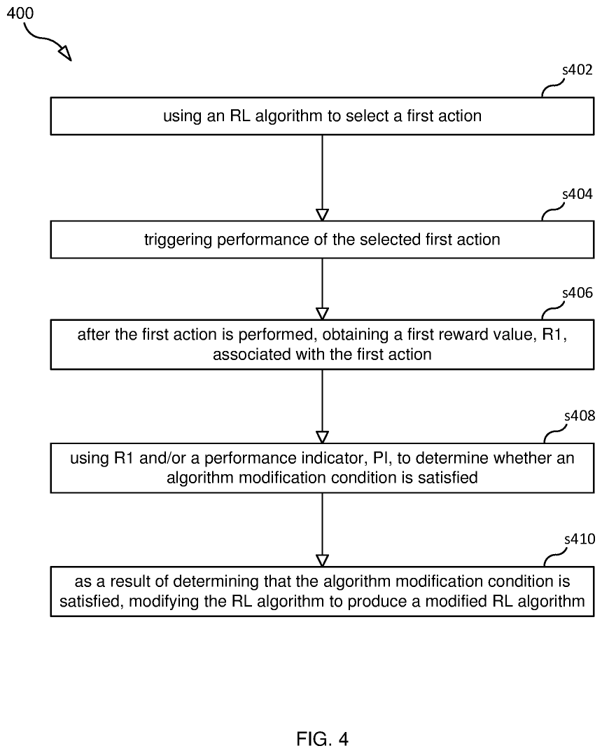

FIG. 4 is a flowchart illustrating a process 400 for dynamic RL. Process 400 may be performed by agent 201 and may begin in step s402. Step s402 comprises using an RL algorithm to select a first action. Step s404 comprises triggering performance of the selected first action. Step s406 comprises, after the first action is performed, obtaining a first reward value (R1) (e.g., the r_{K} value shown above) associated with the first action. Step s408 comprises using R1 and/or a performance indicator (PI) to determine whether an algorithm modification condition is satisfied. Step s410 comprises, as a result of determining that the algorithm modification condition is satisfied, modifying the RL algorithm to produce a modified RL algorithm.

In some embodiments, modifying the RL algorithm to produce the modified RL algorithm comprises modifying a parameter of the RL algorithm.

In some embodiments, modifying a parameter of the RL algorithm comprises modifying one or more of: an exploration probability of the RL algorithm; a learning rate of the RL algorithm, a discount factor of the RL algorithm, or a replay memory capacity of the RL algorithm. In some embodiments, using the RL algorithm to select the first action comprises selecting the first action based on the exploration probability, an modifying the RL algorithm to produce the modified RL algorithm comprises modifying the exploration probability.

In some embodiments, using R1 and/or PI to determine whether the algorithm modification condition is satisfied comprises one or more of i) comparing R1 to a first threshold, ii) comparing ΔR to a second threshold, wherein ΔR is a difference between R1 and a reward value associated with a second action selected using the RL algorithm, or iii) comparing the PI to a third threshold.

In some embodiments, process 400 also includes: i) before using the RL algorithm to select the first action and obtaining R1, using the RL algorithm to select a second action; ii) triggering performance of the selected second action; and iii) after the second action is performed, obtaining a second reward value, R2 (e.g., rₚᵣₑᵥᵢₒᵤₛ), associated with the second action, wherein using R1 and/or PI to determine whether the algorithm modification condition is satisfied comprises performing a decision process comprising: calculating ΔR=R2−R1 and determining whether ΔR is greater than a drop threshold.

In some embodiments, using the RL algorithm to select the first action comprises selecting the first action based on an exploration probability (E). The exploration probability specifies the likelihood that the agent will randomly select an action, as opposed to selecting an action that is determined to yield the highest expected reward. For example, if E is 0.1, then the agent is configured such that when the agent goes to select an action there is a 10% chance the agent will randomly select an action and a 90% chance that the agent will select an action that is determined to yield the highest expected reward.

In some embodiments, the algorithm modification condition is satisfied when ΔR is greater than the drop threshold, and modifying the RL algorithm as a result of determining that the algorithm modification condition is satisfied comprises generating a new exploration probability, ε_{new}, for the RL algorithm, wherein ε_{new} equals ε_{ReStart}, where ε_{NewStart} is a predetermined exploration probability (e.g., ε_{Restart}=0.1).

In some embodiments, the decision process further comprises, as a result of determining that ΔR is not greater than the drop threshold, then determining whether R1 is less than a lower reward threshold.

In some embodiments, the decision process further comprises, as a result of determining that ΔR is not greater than the drop threshold, then determining whether R1 is greater than an upper reward threshold. In some embodiments, the algorithm modification condition is satisfied when ΔR is not greater than the drop threshold and R1 is greater than the upper reward threshold, an modifying the RL algorithm as a result of determining that the algorithm modification condition is satisfied comprises generating a new exploration probability, ε_{new}, for the RL algorithm, wherein ε_{new} equals ε_{End}, where ε_{End} is a predetermined ending exploration probability (e.g., ε_{End}=0.001).

In some embodiments, the algorithm modification condition is satisfied when ΔR is not greater than the drop threshold and R1 is not greater than the upper reward threshold, and modifying the RL algorithm as a result of determining that the algorithm modification condition is satisfied comprises generating a new exploration probability, ε_{new}, for the RL algorithm, wherein ε_{new} equals (E×c), where c is a predetermined constant.

In some embodiments, process 400 further includes, prior to using the RL algorithm to select the action: i) using the RL algorithm to select K−1 actions, where K>1; ii) triggering the performance of each one of the K−1 actions; and iii) for each one of the K−1 actions, obtaining a reward value associated with the action. In some embodiments, using R1 and/or PI to determine whether the algorithm modification condition is satisfied comprises: using R1 and said K−1 reward values to generate a reward value that is a function of these K reward values; and comparing the generated reward value to a threshold. In some embodiments, using R1 and/or PI to determine whether the algorithm modification condition is satisfied comprises: using R1 and said K−1 reward values to generate a reward value that is a function of these K reward values; and comparing ΔR to a threshold, wherein ΔR is a difference between the generated reward value and a previously generated reward value. In some embodiments, the generated reward value is: a sum of the K reward value, a weighted sum of said K reward values, a weighted sum of a subset of said K reward values, a mean of said K reward values, a mean of a subset of said K reward values, a median of said K reward values, or a median of a subset of said K reward values.

In some embodiments, the value of K is determined based on a correlation time of the environment and/or application requirements (e.g., the maximum allowed service interruption time). In some embodiments, the value of K is determined based on a maximum allowed service interruption time.

In some embodiments, one or more of the recited thresholds is dynamically changed based on environment changes and/or service requirement changes.

In some embodiments, process 400 further includes using the modified RL algorithm to select another action and triggering performance of the another action.

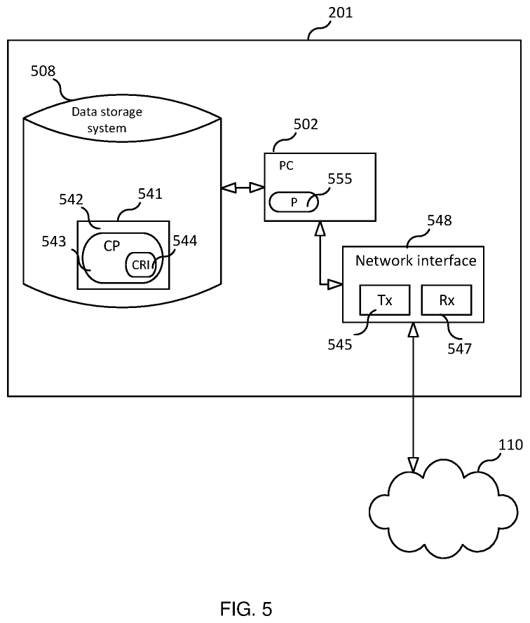

FIG. 5 is a block diagram of RL agent 201, according to some embodiments. As shown in FIG. 5, RL agent 201 may comprise: processing circuitry (PC) 502, which may include one or more processors (P) 555 (e.g., a general purpose microprocessor and/or one or more other processors, such as an application specific integrated circuit (ASIC), field-programmable gate arrays (FPGAs), and the like), which processors may be co-located in a single housing or in a single data center or may be geographically distributed (i.e., RL agent 201 may be a distributed computing apparatus); at least one network interface 548 comprising a transmitter (Tx) 545 and a receiver (Rx) 547 for enabling RL agent 201 to transmit data to and receive data from other nodes connected to a network 110 (e.g., an Internet Protocol (IP) network) to which network interface 548 is connected (directly or indirectly) (e.g., network interface 548 may be wirelessly connected to the network 110, in which case network interface 548 is connected to an antenna arrangement); and a storage unit (a.k.a., “data storage system”) 508, which may include one or more non-volatile storage devices and/or one or more volatile storage devices. In an alternative embodiment the network interface 548 may be connected to the network 110 over a wired connection, for example over an optical fiber or a copper cable. In embodiments where PC 502 includes a programmable processor, a computer program product (CPP) 541 may be provided. CPP 541 includes a computer readable medium (CRM) 542 storing a computer program (CP) 543 comprising computer readable instructions (CRI) 544. CRM 542 may be a non-transitory computer readable medium, such as, magnetic media (e.g., a hard disk), optical media, memory devices (e.g., random access memory, flash memory), and the like. In some embodiments, the CRI 544 of computer program 543 is configured such that when executed by PC 502, the CRI causes RL agent 201 to perform steps of the methods described herein (e.g., steps described herein with reference to one or more of the flow charts). In other embodiments, RL agent 201 may be configured to perform steps of the methods described herein without the need for code. That is, for example, PC 502 may consist merely of one or more ASICs. Hence, the features of the embodiments described herein may be implemented in hardware and/or software.

While various embodiments are described herein, it should be understood that they have been presented by way of example only, and not limitation. Thus, the breadth and scope of this disclosure should not be limited by any of the above-described exemplary embodiments. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1. A method for dynamic reinforcement learning (RL), the method comprising:
using an RL algorithm to select a first action;
triggering performance of the selected first action;
after the first action is performed, obtaining a first reward value, R1, associated with the first action;
using R1 and/or a performance indicator, PI, to determine whether an algorithm modification condition is satisfied;
as a result of determining that the algorithm modification condition is satisfied, modifying the RL algorithm to produce a modified RL algorithm.

2. The method of claim 1, wherein modifying the RL algorithm to produce the modified RL algorithm comprises modifying a parameter of the RL algorithm.

3. The method of claim 2, wherein modifying a parameter of the RL algorithm comprises modifying:
an exploration probability of the RL algorithm,
a learning rate of the RL algorithm,
a discount factor of the RL algorithm, and/or
a replay memory capacity of the RL algorithm.

4. The method of claim 3, wherein
using the RL algorithm to select the first action comprises selecting the first action based on the exploration probability, and
modifying the RL algorithm to produce the modified RL algorithm comprises modifying the exploration probability.

5. The method of claim 1, wherein using R1 and/or PI to determine whether the algorithm modification condition is satisfied comprises one or more of:
comparing R1 to a first threshold,
comparing ΔR to a second threshold, wherein ΔR is a difference between R1 and a reward value associated with a second action selected using the RL algorithm, or
comparing the PI to a third threshold.

6. The method of claim 1, further comprising:
before using the RL algorithm to select the first action and obtaining R1, using the RL algorithm to select a second action;
triggering performance of the selected second action; and
after the second action is performed, obtaining a second reward value, R2, associated with the second action, wherein
using R1 and/or PI to determine whether the algorithm modification condition is satisfied comprises performing a decision process comprising:
calculating ΔR=R2−R1; and
determining whether ΔR is greater than a drop threshold.

7. The method of claim 6, wherein
using the RL algorithm to select the first action comprises selecting the first action based on an exploration probability, E,
the algorithm modification condition is satisfied when ΔR is greater than the drop threshold, and
modifying the RL algorithm as a result of determining that the algorithm modification condition is satisfied comprises generating a new exploration probability, ε_{new}, for the RL algorithm, wherein ε_{new} equals ε_{ReStart}, where ε_{ReStart} is a predetermined exploration probability.

8. The method of claim 6, wherein the decision process further comprises, as a result of determining that ΔR is not greater than the drop threshold, then determining whether R1 is less than a lower reward threshold.

9. (canceled)

10. The method of claim 6, wherein
the decision process further comprises, as a result of determining that ΔR is not greater than the drop threshold, then determining whether R1 is greater than an upper reward threshold,
the algorithm modification condition is satisfied when ΔR is not greater than the drop threshold and R1 is greater than the upper reward threshold, and
modifying the RL algorithm as a result of determining that the algorithm modification condition is satisfied comprises generating a new exploration probability, ε_{new}, for the RL algorithm, wherein ε_{new} equals ε_{end}, where ε_{end} is a predetermined ending exploration probability.

11. The method of claim 6, wherein
the decision process further comprises, as a result of determining that ΔR is not greater than the drop threshold, then determining whether R1 is greater than an upper reward threshold,
the algorithm modification condition is satisfied when ΔR is not greater than the drop threshold and R1 is not greater than the upper reward threshold, and
modifying the RL algorithm as a result of determining that the algorithm modification condition is satisfied comprises generating a new exploration probability, ε_{new}, for the RL algorithm, wherein ε_{new} equals (ε×c), where c is a predetermined constant.

12. The method of claim 1, further comprising, prior to using the RL algorithm to select the first action:
using the RL algorithm to select K−1 actions, where K>1;
triggering the performance of each one of the K−1 actions; and
for each one of the K−1 actions, obtaining a reward value associated with the action.

13. The method of claim 12, wherein using R1 and/or PI to determine whether the algorithm modification condition is satisfied comprises:
using R1 and said K−1 reward values to generate a reward value that is a function of these K reward values; and
comparing the generated reward value to a threshold.

14. The method of claim 12, wherein using R1 and/or PI to determine whether the algorithm modification condition is satisfied comprises:
using R1 and said K−1 reward values to generate a reward value that is a function of these K reward values; and
comparing ΔR to a threshold, wherein ΔR is a difference between the generated reward value and a previously generated reward value.

15. The method of claim 13, wherein the generated reward value is:
a sum of the K reward value
a weighted sum of said K reward values,
a weighted sum of a subset of said K reward values,
a mean of said K reward values,
a mean of a subset of said K reward values,
a median of said K reward values, or
a median of a subset of said K reward values.

16. The method of claim 12, wherein
the value of K is determined based on a correlation time of the environment and/or application requirements, or
the value of K is determined based on a maximum allowed service interruption time.

17. (canceled)

18. The method of claim 1, wherein
one or more of the recited thresholds is dynamically changed based on environment changes and/or service requirement changes, and
the method further comprises using the modified RL algorithm to select another action and triggering performance of the another action.

19. (canceled)

20. A non-transitory computer readable storage medium storing a computer program comprising instructions which when executed by processing circuitry of an agent causes the agent to perform the method of claim 1.

21-22. (canceled)

23. A reinforcement learning (RL) agent, the RL agent comprising:
processing circuitry; and
a memory, the memory containing instructions executable by the processing circuitry, wherein the RL is configured to perform a process comprising:
using an RL algorithm to select a first action;
triggering performance of the selected first action;
after the first action is performed, obtaining a first reward value, R1, associated with the first action;
using R1 and/or a performance indicator, PI, to determine whether an algorithm modification condition is satisfied;
as a result of determining that the algorithm modification condition is satisfied, modifying the RL algorithm to produce a modified RL algorithm.

24. The RL agent of claim 22, wherein
modifying the RL algorithm to produce the modified RL algorithm comprises modifying a parameter of the RL algorithm, and
modifying a parameter of the RL algorithm comprises modifying:
an exploration probability of the RL algorithm,
a learning rate of the RL algorithm,
a discount factor of the RL algorithm, and/or
a replay memory capacity of the RL algorithm.
